(19) United States
(12) Patent Application Publication
(10) Pub. No.: US 2008/0213534 A1
(43) Pub. Date: Sep. 4, 2008

(54) GRAINED PARTING LINES IN MOLD FOR FOAM ARTICLES

(76) Inventors: James T. McEvoy, Howell, MI (US); Ryoko Yamasaki, Ypsilanti, MI (US); Patricia J. McClarren, Ypsilanti, MI (US); Weihan Li, Ypsilanti, MI (US)

Correspondence Address: DICKINSON WRIGHT PLLC, 1901 L. STREET NW, SUITE 800, WASHINGTON, DC, 20036, US

(21) Appl. No.: 11/969,376

(22) Filed: Jan. 4, 2008

Related U.S. Application Data
(60) Provisional application No. 60/878,659, filed on Jan. 5, 2007.

(51) Int. Cl. B32B 3/02

(52) U.S. Cl. 428/108; 425/4 R; 264/48

(57) ABSTRACT

A multi-section mold and method for molding a foam article. Micro-groove vents are formed in the parting line to expel gases from the mold cavity. Flashing that solidifies in the micro-groove vents takes the form of fringe-like elements. The roof of the mold cavity can be provided with similar micro-groove graining patterns to disrupt the accumulation of gas bubbles and minimize defects in the final foam surface.

### CROSS REFERENCE TO RELATED APPLICATIONS

This Application claims priority to U.S. Provisional Application No. 60/878,659 filed Jan. 5, 2007.

### BACKGROUND OF THE INVENTION

1. Field of the Invention

This invention relates to a mold for producing foam articles, and more specifically to a method for molding foam seat cushions without voids.

2. Related Art

Foam articles can be molded by placing an uncured liquid foam formulation composition in a mold cavity. The foam composition then changes from a liquid to a solid during the curing process. The foam composition expands, gives off gases, and takes on the form of the mold cavity. This technique can be used to make foam cushions for vehicle seats, including automobile seats, for example. After the molding operation is complete, the foam cushion may be installed in a seat frame and then covered with vinyl, cloth or leather to produce a finished vehicle seat.

Clam-shell molds typically are used to mold the foam composition into the final foam article. These claim-shell molds can include a bottom mold section (sometimes referred to as a bowl) and a top mold section (sometimes called a lid) which, when brought together define the mold cavity in a space enclosed there between. The final foam article has a parting line where the top and bottom mold sections meet when closed. Sometimes, a seat back (or other component) will be designed with inserts or undercuts that are difficult to form in a basic two piece mold, in which case the three (or more) section mold may be employed. For example, a three piece mold may be designed with a center insert section that allows for a back seat cushion or other article with complex features to be made.

As mentioned, during the molding process, the foam composition changes physically and expands, creating carbon dioxide gas and amine-composed gas inside the mold cavity. That gas must escape, together with any air resident in the mold cavity, as the foam composition expands to fill the mold cavity. To enable escape of this gas, the mold must provide a vent. In some examples, the vents are formed as large grooves or vents at the mold parting line. This type of venting is illustrated in U.S. Pat. No. 6,352,659 issued Mar. 5, 2002, the entire disclosure of which is hereby incorporated by reference. Along with the gases, a small portion of the foam material is allowed to escape from the mold cavity through the large vents caused by either back pressure or capillary action, or a combination of the two. Any trapped gases collect in the roof of the mold as bubbles, which result in defects known as voids. Such defects appearing in the formed final foam article must be filled or otherwise addressed before the article can be further processed.

FIGS. 3-7 and 18 depict conventional or prior art mold and article products made using technology of the type just described, where large vents are formed at the parting line. As shown in FIGS. 7 and 18, when the foam composition changes physically and expands, bubbles can form along the upper surface, or the so-called B-surface, of the foam article which results from the negative impression of the upper cavity portion of the top mold section. Another shortcoming or disadvantage of the prior art mold construction and technique can be seen by reference to FIG. 7, wherein large, tab-like pieces of flashing in the finished foam article, solidified in the vents, must be trimmed before further processing. Such trimming operations are time consuming and therefore expensive in high production manufacturing settings.

Various strategies have been suggested for addressing these issues. For example, U.S. Pat. No. 5,772,936 issued Jun. 30, 1998 describes a mold process in which venting of gases is manipulated by controlling contact pressure at the parting line. In another example, U.S. Publication No. 2005/0253293, published Nov. 17, 2005, describes the formation of a groove network in the upper cavity portion of the top mold section for channeling and routing gases to a centrally located vent device which is not associated with the parting line between the molds. This process requires expensive venting components and has not proven to be a robust process conducive to high production manufacturing scenarios. U.S. Pat. No. 2,752,635 issued Jul. 3, 1956 describes a mold assembly for foam articles, for example seat cushions, in which a criss-crossing network of grooves are formed in the upper cavity portion of the top mold section to vent gases through the parting line between the two clam-shell mold sections. These large, unequally spaced grooves are interrupted in every course by core pins, and thereby prevent full use of the groves to adequately control trapped gases.

Accordingly, there is a need in the art for an improved mold and a method for making molded foam articles that minimizes the presence of voids in the B-surface of the final molded foam article, and which does not produce large pieces of flashing that must be subsequently trimmed in a time consuming manner from the final foam article.

### SUMMARY OF THE INVENTION

The subject invention overcomes the shortcomings and disadvantages of prior art mold systems and methods by providing a mold for a foam article such as a seat cushion comprising a bottom mold section having a lower cavity portion and a bottom flange surrounding the lower cavity portion, and a top mold section having an upper cavity portion and an upper flange surrounding the upper cavity portion. The top mold section is moveably disposed relative to the bottom mold section and is arranged so that the upper and lower cavity portions oppose one another to form an enclosed mold cavity. Likewise, the upper and lower flanges engage in abutting contact to establish a parting line for the mold cavity. At least one of the upper and lower flanges includes a plurality of micro-groove vents radiating outwardly from the mold cavity so that foam that escapes from the mold cavity as a result of expansion during the curing process will propagate along the micro-grooves and solidify as discrete fringe-like flashing elements.

According to another aspect of this invention, a foam article formed in a multi-section mold separated by a parting line is provided. The foam article comprises an upper surface formed by impression against an upper cavity portion of a top mold section and a lower surface formed by impression against a lower cavity portion of a bottom mold section. Flashing is formed by escape of uncured foam material through the parting line separating the top and bottom mold sections. The flashing comprises a plurality of discrete fringe-like flashing elements radiating away from the upper surface along defined, non-intersecting courses of generally equal width but variable length.

According to a still further embodiment of this invention, a method is provided for molding a curable foam article in a multi-section mold separated by a parting line. The method comprises the steps of: providing a bottom mold section having a lower cavity portion surrounded by a lower flange, partially filling the lower cavity portion of the mold with an uncured foam material; providing an upper mold section having an upper cavity portion surrounded by an upper flange, covering the bottom mold section in the uncured foam material with the upper mold section so that the upper and lower cavity portions oppose one another and the upper and lower flanges engage in abutting contact to form the parting line for the mold cavity, curing the foam in the mold cavity and simultaneously expanding the foam to fill the mold cavity, venting air resident in the mold cavity through a plurality of micro-groove vents formed in at least one of the upper and lower flanges, and allowing foam material to escape from the mold cavity through the micro-groove vents and fully cure therein as fringe-like flashing elements.

The subject invention as presented in these various aspects provides an improved mold and method for making molded foam articles that both minimizes the presence of voids in the final molded foam article as well as reducing the labor required to trim flash from the final foam article.

### BRIEF DESCRIPTION OF THE DRAWINGS

These and other features and advantages of the present invention will become more readily appreciated when considered in connection with the following detailed description and appended drawings, wherein:

FIG. 1 is a perspective view of an exemplary motor vehicle including a seat having a cushion which is made as a foam molded article according to the subject invention;

FIG. 2 is an enlarged view of a seat such as may be used in a vehicle and which includes a seat cushion that is manufactured in a molding process according to the subject invention;

FIG. 3 is a schematic view of a typical prior art mold shown in cross-section in which is deposited uncured foam material;

FIG. 4 is a fragmentary cross-sectional view of the upper flange of the top mold section as taken generally along lines 4-4 in FIG. 3;

FIG. 5 is a schematic cross-sectional view as in FIG. 3 but illustrating the foam material expanded and cured to entirely fill the mold cavity with portions thereof escaping through the large vents formed at the parting line;

FIG. 6 is a view as in FIG. 5 but showing the sections of the clam-shell mold separated in a step where the cured, molded foam article may be removed for subsequent processing;

FIG. 7 is a fragmentary view of the upper surface of the formed foam article as taken generally along lines 7-7 in FIG. 6;

FIG. 8 is a schematic cross-sectional view showing a mold for a foam article according to the subject invention, wherein the mold cavity is partially filled with uncured foam material in an early stage of the forming process;

FIG. 9 is an enlarged cross-sectional view of the top mold section;

FIG. 10 is a fragmentary view of the top mold section and its upper flange as taken generally along lines 10-10 in FIG. 9 and illustrating micro-groove vents formed along the upper flange and micro-groove grain patterns formed in the top mold section;

FIG. 11 is a view as in FIG. 10, showing an alternative pattern for the micro-groove grain patterns as formed in the top mold section;

FIG. 12 is a view as in FIG. 10, illustrating an alternative pattern for the micro-groove vents formed in the upper flange and wherein the upper cavity portion is devoid of micro-groove grain patterns;

FIG. 13 is a cross-sectional view as in FIG. 8, illustrating a later moment in the curing process wherein the foam material has expanded to fill the entire mold cavity;

FIG. 14 illustrates the top and bottom mold sections separated from one another so that the molded foam article can be removed for subsequent processing;

FIG. 15 is a fragmentary view of the molded foam article as seen generally along lines 15-15 in FIG. 14;

FIG. 16 is an enlarged view of the micro-groove grain patterns as taken from the circumscribed area 16 in FIG. 14;

FIG. 17 is a view as in FIG. 16, illustrating the foam material expanded to contact the upper cavity portion with entrapped air bubble being divided by the micro-groove grain pattern; and

FIG. 18 is a comparable view to FIG. 17, but illustrating a prior art design wherein the upper cavity portion is not formed with micro-groove grain patterns and therefore gas bubbles become trapped and accumulate in relatively large, undesirable areas.

### DETAILED DESCRIPTION OF THE PREFERRED EMBODIMENT

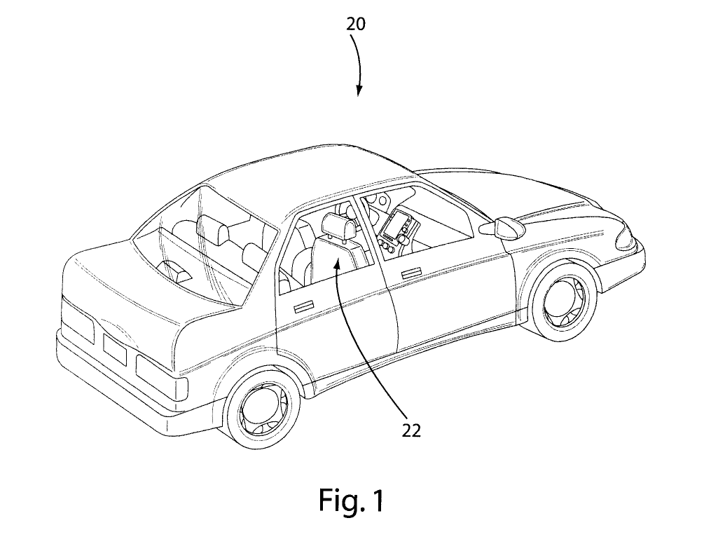

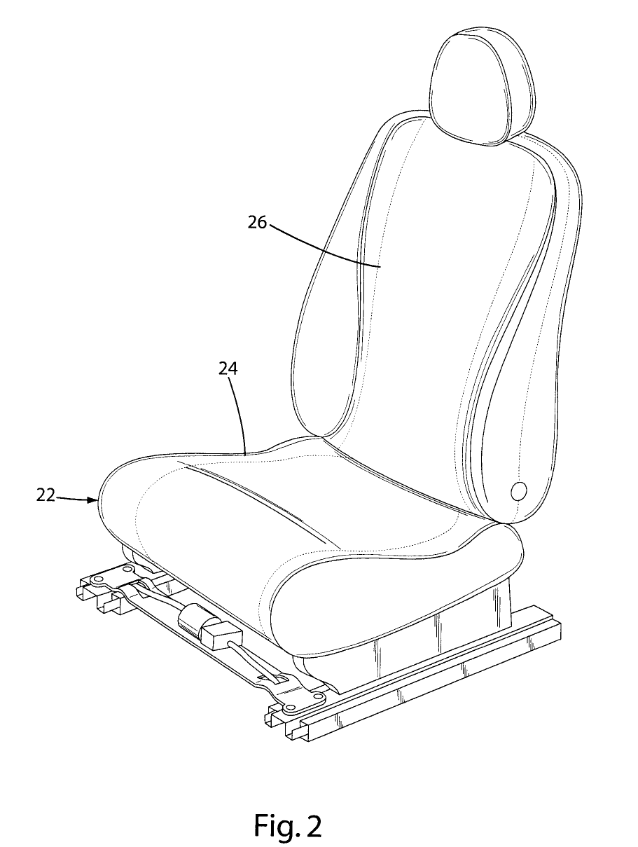

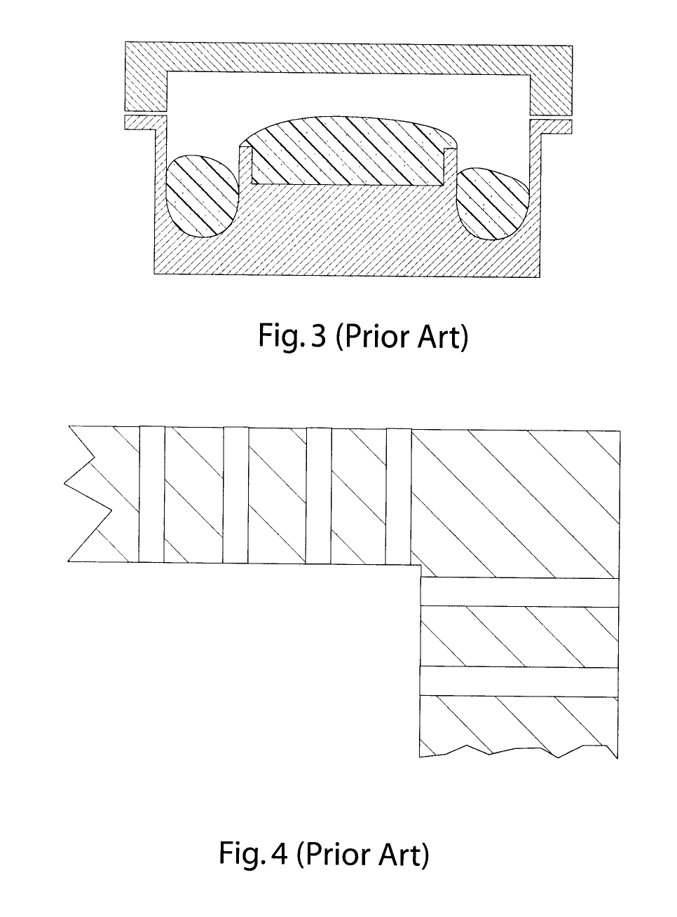

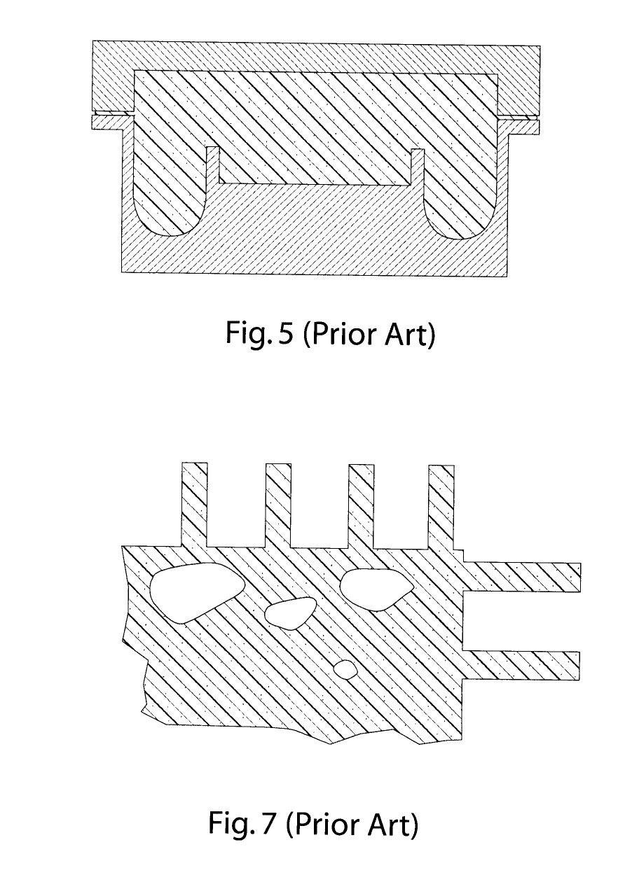

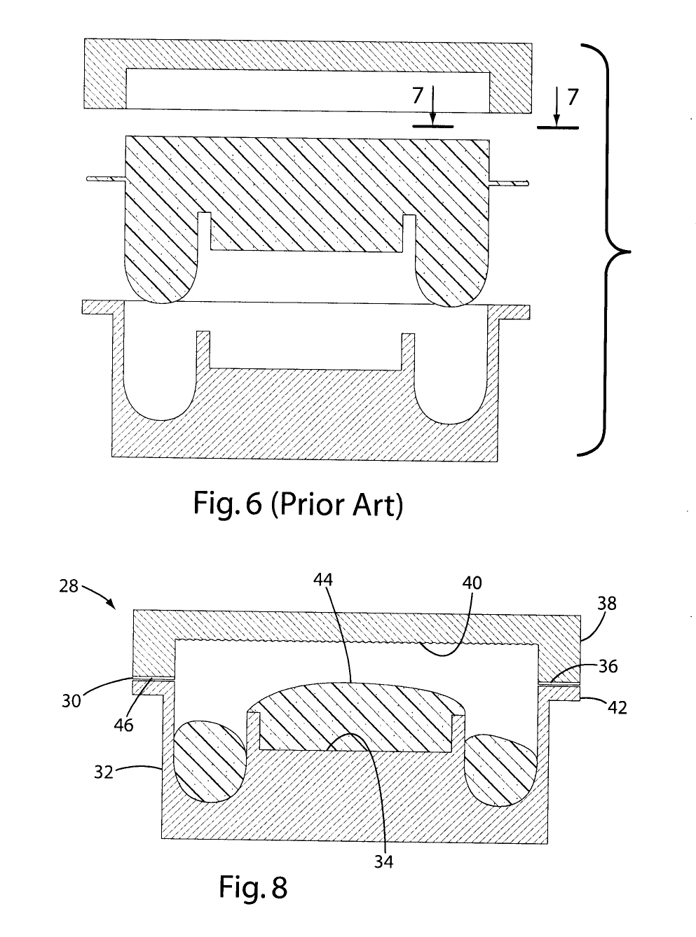

Referring to the Figures, wherein like numerals indicate like or corresponding parts throughout the several views, an exemplary motor vehicle is generally shown at 20 in FIG. 1. The motor vehicle 20 includes a seat assembly, generally indicated at 22. As shown in FIG. 2 the seat assembly 22 is provided with a seating portion 24 and a back rest portion 26. The seating 24 and backrest 26 portions are preferably manufactured from a foam core supported in a frame and covered with a covering material according to known techniques. Although the subject invention is not limited to manufacturing seat cushions, it is nevertheless particularly well suited to this application, so that the following description will, for convenience, be carried out in the context of foam seat cushions for use in a vehicle 20.

Turning now to FIG. 8, an exemplary claim-shell type mold assembly is shown schematically in cross-section, such as of the type for forming the foam core for the seating portion 24 of a seat assembly 22. Here is it shown that the cushion will be formed in an upside down orientation, with its “A-surface” being formed at the bottom and its “B-surface” being formed along the top. This is a common molding practice so that any surface defects tend to migrate toward the B-surface. More specifically, the mold assembly, generally indicated at 28, is formed as a two-section or clam-shell type mold separated by a parting line 30. A bottom mold section 32 is formed to have a lower cavity portion 34 which, in this example, establishes the A-surface of the seat cushion by negative impression. The lower cavity portion 34 is surrounded by a bottom flange 36. In this example, the bottom flange 36 is suggested to be somewhat planar, but in practice the bottom flange 36 may be undulating to better obscure the resulting parting line 30.

The mold assembly 28 further includes a top mold section 38 which, like the bottom mold section 32, has an upper cavity portion 40 formed therein and a flange 42 surrounding the upper cavity portion 40. The top section 38 is movably disposed relative to the bottom mold section 32 such as by a press, air bag, or other technique common in the molding arts. The top 38 and bottom 32 mold sections are arranged so that their upper 40 and lower 34 cavity portions oppose one another to form an enclosed mold cavity which is representative of the final, formed foam article. In this condition, the upper 42 and lower 36 flanges engage in abutting contact to establish the parting line 30 for the mold cavity.

Although the technical description and illustrations use a basic two-section clam-shell style mold assembly 28 as an example, it will be appreciated by those of skill in the art that the novel aspects of this invention can be accomplished in any multi-section mold. For example, a three (or more) section mold assembly may be employed with equal effectiveness to form back seat cushion or other articles with complex features that might otherwise be difficult to form in the basic two piece mold assembly 28.

A quantity of uncured foam material 44 is deposited in the lower cavity portion 34 as illustrated in FIG. 8. The specific composition of the uncured foam 44 may include the polyurethane composition types such as described in greater detail in U.S. Pat. No. 5,772,936 issued Jun. 30, 1998, the entire disclosure of which is hereby incorporated by reference. Alternatively, the foam 44 may comprise any other suitable material which has been or will be developed for these applications. In its uncured state, the foam 44 only partially fills the mold cavity. As the foam 44 cures through a chemical reaction, which may be accelerated or provoked by heat or other agents, the foam 44 expands to fill the entire mold cavity. During this process, the air trapped together with the foam 44 must be displaced from the mold cavity. Furthermore, the curing foam composition may produce gases, such as carbon dioxide and/or amine-composed gases, that also must be expelled from the mold cavity.

To facilitate evacuation of gases from the mold cavity, at least one of the upper 42 and lower 36 flanges are provided with a plurality of micro-groove vents 46 that radiate outwardly from the mold cavity. Through these micro-groove vents 46, gases escape directly to atmosphere, and also foam 44 may escape from the mold cavity as a result of the expansion and curing processes. This escaping foam 44 propagates along the micro-groove vents 46 and solidifies as discrete, fringe-like flashing elements 48, as illustrated in FIG. 15.

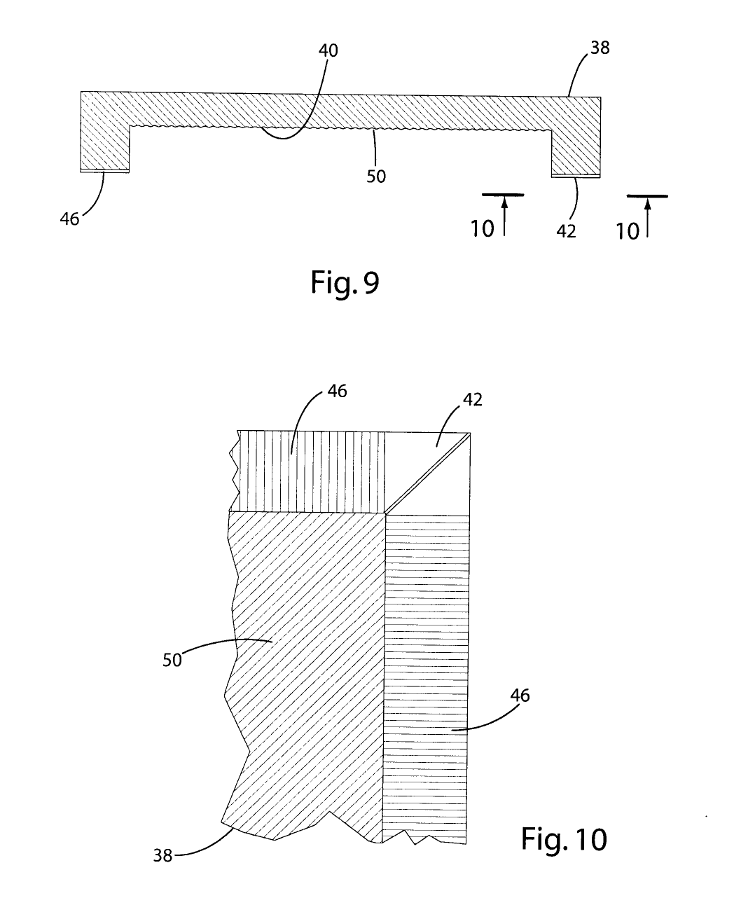

An enlarged view of the top mold section 38 is illustrated in FIG. 9, with the micro-groove vents 46 illustrated in profile as grooves, channels or furrows that route gases to atmosphere. FIG. 10 illustrates the micro-groove vents 46 in plan view. Here, the micro-groove vents 46 are shown oriented generally perpendicular to the extent of the upper flange 42, with a single micro-groove oriented on a diagonal expressing gas through the corner. The micro-groove vents 46 are arranged in non-intersecting rows that are spaced apart one from another a very small distance. Preferably, the spacing, or pitch (P), between adjacent micro-groove vents is less than or equal to about 1.0 millimeter and greater than or equal to about 0.25 millimeters.

FIG. 12 illustrates an alternative embodiment wherein the micro-groove vents 146 are oriented obliquely relative to the flange width and length. In FIG. 12, previously described reference numbers are offset by “100.” Thus, the alternative micro-groove vent 146 orientation assumes a generally skewed or angled appearance.

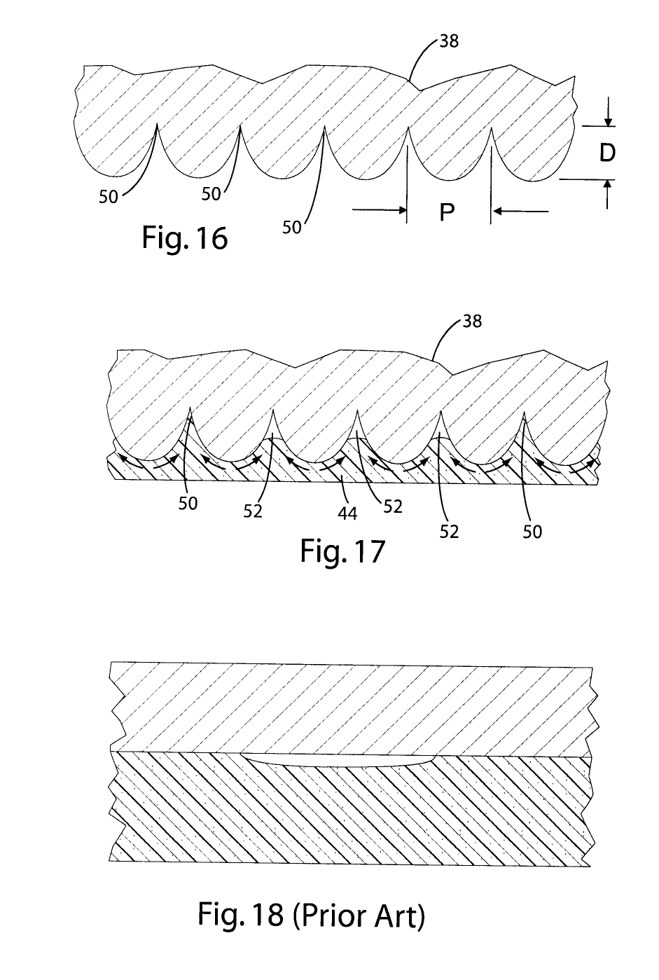

Referring again to FIGS. 9 and 10, the upper cavity portion 40 of the top mold section 38 may include a plurality of closely spaced micro-groove graining patterns 50 formed therein and radiating toward the upper flange 42. Like the micro-groove vents 46, the micro-groove graining patterns 50 are also non-intersecting and preferably spaced apart one from another by pitch distance P determined by the formula 0.25 mm≦P≦1.0 mm. FIG. 16 illustrates an enlarged cross-sectional view of the micro-groove graining patterns 50, with the pitch distance P dimensioned in relation to the groove depth D. Preferably, the groove depth D also is determined by the formula 0.25 mm≦D≦1.0 mm. However, it is not necessary that both pitch P and depth D for the micro-groove graining patterns 50 be equal to one another. Also as illustrated FIG. 16, it is shown that the micro-groove graining patterns 50 have a generally V-shaped root with a generally rounded ridge-like crest separating one micro-groove graining pattern 50 from the next adjacent micro-groove graining pattern 50. This configuration, while not exclusive to achieve the advantages of this invention, is particularly well suited for altering the surface tension in the uncured foam 44 as will be described subsequently.

Preferably, the configuration of the micro-groove vents 46 is identical or substantially identical, to that described above in connection with the micro-groove graining patterns 50. Thus, the micro-groove vents 46 will conform to dimensional parameters and shapes as illustrated in FIG. 16 and as described in connection with the micro-groove graining patterns 50 above.

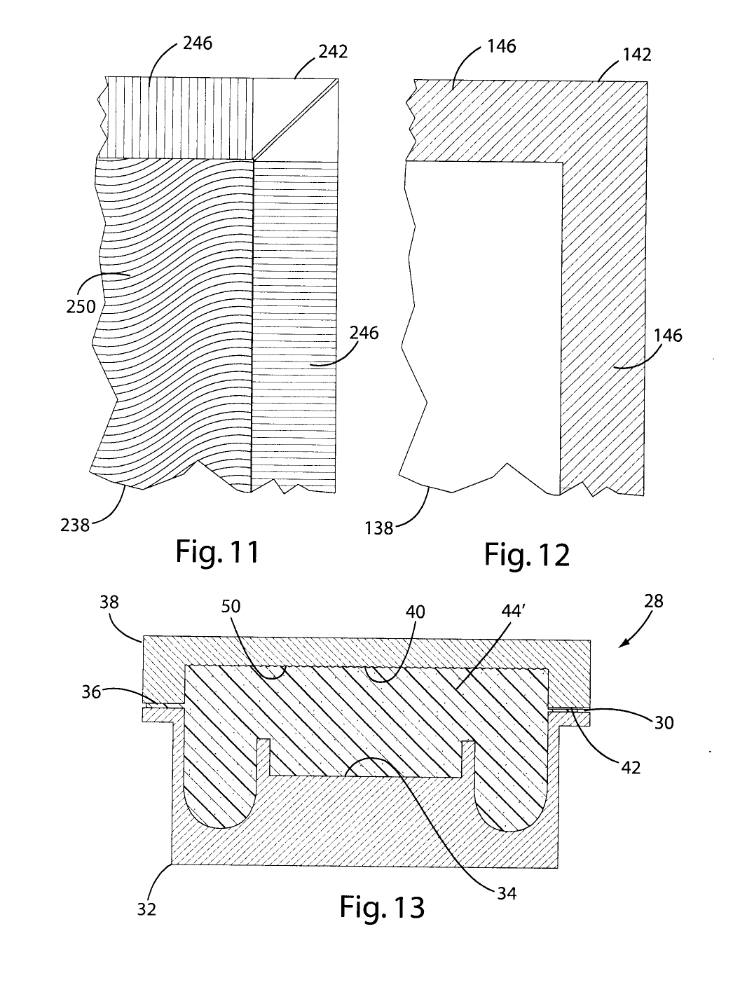

As shown in FIG. 10, the micro-groove graining pattern 50 may be arranged as a linear array extending at an oblique angle relative to the radiating micro-groove vents 46. This is but one example of many possible orientations for the micro-groove graining patterns 50. FIG. 11 illustrates an alternative view, wherein the micro-groove graining patterns 250 are shown having a curvilinear pattern. In FIG. 11, previously presented components are identified with like or corresponding reference numbers offset by “200.” Such curving patterns can be used to simulate wood or leather grains, or other artistic patterns while still maintaining a non-intersecting and generally parallel nature of one micro-groove graining pattern furrow relative to the next adjacent furrow. In all of these examples, the non-intersecting courses of the micro-groove graining patterns 50, 250 join or merge or terminate with a respective one of the micro-groove vents 46, 246 to provide a continuous pathway for escaping gases to exit from within the mold cavity.

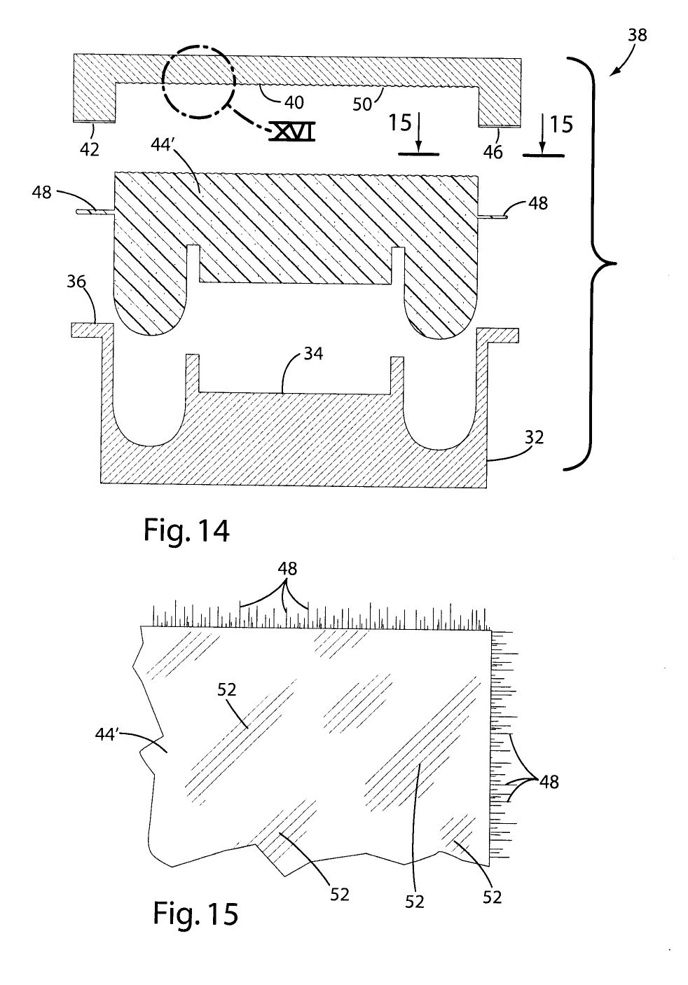

A finished, cured foam article 44′ is illustrated in FIGS. 13-15. The cured foam article 44′ has taken the shape of the interior mold cavity and in this state is self-supporting to retain its shape once removed from the mold cavity as illustrated in FIG. 14. In FIG. 15, the fringe-like flashing elements 48 are shown extending laterally away from the edges of the finished article 44′ as a result of excess foam material that escaped from the mold cavity and solidified as discrete elements. These flashing elements 48 are non-intersecting and have generally equal widths but variable lengths which are somewhat randomly determined.

Disrupted bubble forms are indicated in FIG. 15 as patches of discrete bubble furrows 52 dispersed about the upper surface of the final foam article 44′. The divided bubble forms characteristic of the subject invention are perhaps best understood by comparison to a prior art mold of FIG. 18, wherein gasses trapped in the mold cavity congregate at the top surface (B-surface) of the formed article, thereby solidifying into a void which is considered a defect in the final product. Such a defect must be filled before further processing. By contrast, however, as shown in FIG. 17, the micro-groove graining patterns 50 divide the gas bubbles into a plurality of discrete bubble furrows 52 and thereby mitigate the void blemish.

Furthermore, the micro-groove graining patterns 50 have the effect of altering the surface tension of the uncured foam in response to its contact with the upper cavity portion. This alteration in the surface tension serves to further reduce the size of the included bubble form by diminishing the displacement of foam caused by the trapped gas. Said another way, the surface tension which may be represented by the directional arrows in FIG. 17 has the effect of pushing the uncured foam 44 deeper into the V-shaped root of the micro-groove graining pattern 50, and thereby diminishing the size or volume that the trapped gas would otherwise create in opposition to the foam. The end result is smaller included bubbles that are divided into defined, non-intersecting courses of generally equal width and which preferably will not need to be filled or treated post-molding.

A method according to this invention is provided for molding a curable foam article 44′ in a two section mold assembly 28 that is separated by a parting line 30. The method includes the steps of providing a bottom mold section 32 having a lower cavity portion 34 surrounded by a lower flange 36, and then partially filling the lower cavity portion 34 of the mold assembly 28 with an uncured foam material 44. The method goes on to include the step of providing a top mold section 38 having an upper cavity portion 40 that is surrounded by an upper flange 42. Next, the bottom mold section 32 is covered, together with the uncured foam material 44, by the top mold section 38 so that the upper 40 and lower 34 cavity portions oppose one another and the upper 42 and lower 36 flanges engage in abutting contact to form the parting line 30 for the mold cavity. Next, the foam 44 is cured in the mold cavity and simultaneously expands to fill the mold cavity. Gases are vented from the mold cavity through a plurality of micro-groove vents 46 formed in at least one of the upper 42 and lower 36 flanges. Foam material is allowed to escape from the mold cavity through the micro-groove vents 46 and to fully cure therein as fringe-like flashing elements 48. As noted above, the foam has a surface tension, and the step of curing the foam 44 includes altering its surface tension in response to contact with the upper cavity portion 40. This step of altering the surface tension includes the further step of penetrating the foam surface with a plurality of micro-ridges. According to the one alternative embodiment of this invention as depicted in FIG. 11, this step of penetrating the foam surface may also include routing the micro-ridges along a curvilinear path.

The step of curing the foam 44 may include inadvertently trapping air or other gases in bubble form against the upper cavity portion 40. When this happens, the gas bubbles are divided into multiple discrete bubble furrows 52 along defined, non-intersecting courses of generally equal width. Thereby, the blemish or flaw caused by this included bubble is minimized such that little or no follow up treatment is required in the form of patching.

The foregoing invention has been described in accordance with the relevant legal standards, thus the description is exemplary rather than limiting in nature. Variations and modifications to the disclosed embodiment may become apparent to those skilled in the art and fall within the scope of the invention. For example, a three (or more) piece mold assembly may be used with a center insert section that allows for a back seat cushion (or other article) to be made. However, use of a multi-piece mold assembly does not interfere with the grooving or placement. Accordingly the scope of legal protection afforded this invention can only be determined by studying the following claims.

What is claimed is:

1. A mold for a foam article such as a seat cushion, said mold comprising:
a bottom mold section having a lower cavity portion and a bottom flange surrounding said lower cavity portion;
a top mold section having an upper cavity portion and an upper flange surrounding said upper cavity portion, said top mold section being movably disposed relative to said bottom mold section and arranged so that said upper and lower cavity portions oppose one another to form an enclosed mold cavity when said upper and lower flanges engage in abutting contact to establish a parting line for said mold cavity; and
at least one of said upper and lower flanges including a plurality of micro-groove vents radiating outwardly from said mold cavity so that foam escaping from said mold cavity as a result of expansion and curing will propagate along said micro-groove vents and solidify as discrete fringe-like flashing elements.

2. The mold of claim 1 or in said micro-groove vents are non-intersecting.

3. The mold of claim 2 wherein said micro-groove vents are spaced apart one from another by a pitch distance (P) determined by the formula 0.25 mm≦P≦1.0 mm.

4. The mold of claim 1 wherein said micro-groove vents have a generally V-shaped root with a generally rounded ridge-like crest separating one micro-groove vent from the next adjacent micro-groove vent.

5. The mold of claim 1 wherein said micro-groove vents are formed in said upper flange.

6. The mold of claim 5 wherein said upper cavity portion of said top mold section includes a plurality of closely spaced micro-groove graining patterns radiating toward said upper flange.

7. The mold of claim 6 wherein said micro-groove graining patterns are non-intersecting.

8. The mold of claim 7 wherein said micro-groove graining patterns are spaced apart one from another by a pitch distance (P) determined by the formula 0.25 mm≦P≦1.0 mm.

9. The mold of claim 8 wherein said micro-groove grain patterns are curvilinear.

10. The mold of claim 8 wherein said micro-groove grain patterns have a generally V-shaped root with a generally rounded ridge-like crest separating one micro-groove graining pattern from the next adjacent micro-groove graining pattern.

11. A foam article formed in a multi-section mold separated by a parting line, said article comprising:
an upper surface formed by impression against an upper cavity portion of a top mold section;
a lower surface formed by impression against a lower cavity portion of a bottom mold section; and
a flashing formed by escape of uncured foam material through the parting line separating the top and the bottom mold sections;
wherein said flashing comprises a plurality of discrete fringe-like flashing elements radiating away from said upper surface along defined, non-intersecting courses of generally equal width but variable length.

12. The article of claim 10 wherein each of said flashing elements has a width not greater than 1.0 mm.

13. The article of claim 11 wherein said upper surface of said foam article has a plurality of micro-groove graining patterns that are non-intersecting and that radiate toward said flashing elements.

14. The article of claim 14 wherein said micro-groove graining patterns are curvilinear.

15. A method for molding a curable foam article in a multi-section mold separated by a parting line, said method comprising the steps of:
providing a bottom mold section having a lower cavity portion surrounded by a lower flange;
partially filing a lower cavity portion of the mold with an uncured foam material;
providing a top mold section having an upper cavity portion surrounded by an upper flange;
covering the bottom mold section and the uncured foam material with the top mold section so that the upper and lower cavity portions oppose one another and the upper and lower flanges engage in abutting contact to form the parting line for the mold cavity;
curing the foam in the mold cavity and simultaneously expanding the foam to fill the mold cavity;
venting gases from the mold cavity through a plurality of micro-groove vents formed in at least one of the upper and lower flanges; and
allowing foam material to escape from the mold cavity through the micro-groove vents and fully cure therein as fringe-like flashing elements.

16. The method of claim 15 wherein the foam has a surface tension, and wherein said step of curing the foam includes altering the surface tension of the foam in response to its contacting the upper cavity portion.

17. The method of claim 16 wherein said step of altering the surface tension includes penetrating the foam surface with a plurality of micro-groove graining patterns.

18. The method of claim 17 wherein said step of penetrating the foam surface includes routing the micro-groove graining pattern along a curvilinear path.

19. The method of claim 15 wherein said step of curing the foam includes inadvertently trapping gases in bubble form adjacent to the upper cavity portion, and wherein said step of inadvertently trapping gases in bubble form includes dividing the bubble forms into a plurality of discrete bubble furrows along defined, non-intersecting courses of generally equal width.
